(19) United States
(12) Patent Application Publication
(10) Pub. No.: US 2025/0013163 A1
(43) Pub. Date: Jan. 9, 2025

(54) RESIN PARTICLE, TONER, TONER ACCOMMODATING UNIT, IMAGE FORMING APPARATUS, AND IMAGE FORMING METHOD

(71) Applicants: Suzuka Karato, Shizuoka (JP); Yuka Mizoguchi, Shizuoka (JP); Akio Takei, Shizuoka (JP); Junichi Watanabe, Shizuoka (JP); Shinya Nakayama, Shizuoka (JP)

(72) Inventors: Suzuka Karato, Shizuoka (JP); Yuka Mizoguchi, Shizuoka (JP); Akio Takei, Shizuoka (JP); Junichi Watanabe, Shizuoka (JP); Shinya Nakayama, Shizuoka (JP)

(73) Assignee: Ricoh Company, Ltd., Tokyo (JP)

(21) Appl. No.: 18/762,222

(22) Filed: Jul. 2, 2024

(30) Foreign Application Priority Data
Jul. 6, 2023 (JP) 2023-111384

(51) Int. Cl. G03G 9/087; G03G 15/08; G03G 15/20

(52) U.S. Cl. CPC G03G 9/08755; G03G 9/08775; G03G 15/0812; G03G 15/2017; G03G 2215/026

(57) ABSTRACT

A resin particle contains a resin B containing a component derived from at least one of polyethylene terephthalate or polybutylene terephthalate and a biomass-derived resin C containing a linear aliphatic alcohol with 2 to 4 carbon atoms and a linear aliphatic acid with 10 to 12 carbon atoms, wherein the resin particle has a core shell structure of a core resin and a shell resin, the core resin contains a crystalline resin, and the proportion of the sum of the resin B and the resin C to 100 percent by mass of the resin particle is 30 or greater percent by mass.

### CROSS-REFERENCE TO RELATED APPLICATIONS

This patent application is based on and claims priority pursuant to 35 U.S.C. § 119 to Japanese Patent Application No. 2023-111384, filed on Jul. 6, 2023, in the Japan Patent Office, the entire disclosure of which is hereby incorporated by reference herein.

### BACKGROUND

### Technical Field

The present disclosure relates to a resin particle, a toner, a toner accommodating unit, an image forming apparatus, and an image forming method.

### Description of the Related Art

In recent years, there has been a demand for toner with a reduced environmental impact. Researchers have thus studied ways to solve this issue, such as developing a toner capable of fixing at lower temperatures to save power, reducing the energy consumed in manufacturing toner, and adopting biomass-derived resin as a binder resin.

Additionally, population growth in recent years has accelerated energy consumption, causing resource depletion. This situation increases the importance of resource conservation, energy conservation, and resource recycling. Specifically, local towns and cities have already started recycling polyethylene terephthalate (PET) and polybutylene terephthalate (PBT) bottles, and the recycled products are used for making clothes and containers. The use of recycled PET and PBT is also expected to expand into new application fields. From this perspective, toner—specifically, recycled toner—containing a binder resin made from collected polyethylene terephthalate has already been developed.

Currently, toner should enhance its functions by using the plant-based resin mentioned above to reduce environmental impact. However, pursuing toner that can be fixed at lower temperatures introduces the problem of unstable storage in high-temperature environments.

### SUMMARY

According to embodiments of the present disclosure, a resin particle is provided which contains a resin B containing a component derived from at least one of polyethylene terephthalate or polybutylene terephthalate and a biomass-derived resin C containing a linear aliphatic alcohol with 2 to 4 carbon atoms and a linear aliphatic acid with 10 to 12 carbon atoms, wherein the resin particle has a core shell structure of a core resin and a shell resin, the core resin contains a crystalline resin, and the proportion of the sum of the resin B and the resin C to 100 percent by mass of the resin particle is 30 or greater percent by mass.

As another aspect of embodiments of the present disclosure, a toner is provided which contains the resin particle mentioned above.

As another aspect of embodiments of the present disclosure, a toner accommodating unit is provided which accommodates the toner 4 mentioned above.

As another aspect of embodiments of the present disclosure, an image forming apparatus is provided which includes a latent electrostatic image bearer, a latent electrostatic image forming device to form a latent electrostatic image on the latent electrostatic image bearer, a developing device to develop the latent electrostatic image on the latent electrostatic image bearer with the toner mentioned above to form a toner image, a transfer device to transfer the toner image on the latent electrostatic image bearer onto a surface of a recording medium, and a fixing device to fix the toner image on the surface of the recording medium.

As another aspect of embodiments of the present disclosure, an image forming method is provided which includes forming a latent electrostatic image on a latent electrostatic image bearer, developing the latent electrostatic image formed on the latent electrostatic image bearer with the toner mentioned above to form a toner image, transferring the toner image formed on the latent electrostatic image bearer to the surface of a recording medium, and fixing the toner image on the surface of the recording medium.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating an image forming apparatus according to an embodiment of the present invention; and

FIG. 2 is a schematic diagram illustrating an example of a process cartridge using an embodiment of the present invention.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure, a resin particle is provided that imposes less burden on the environment and has excellent low temperature fixability and high temperature storage stability.

The resin particle of the present invention has a core-shell structure with a core resin and a shell resin.

The resin particle contains a resin B containing a component derived from at least one of polyethylene terephthalate or polybutylene terephthalate and a biomass-derived resin C containing a linear aliphatic alcohol with 2 to 4 carbon atoms and a linear aliphatic acid with 10 to 12 carbon atoms, wherein the resin particle has a core shell structure of a core resin and a shell resin, the core resin contains a crystalline resin, and the proportion of the sum of the resin B and the resin C to 100 percent by mass of the resin particle is 30 or greater percent by mass.

To become environment-friendly, these resin particles need to incorporate more biomass and recycled resins not only in the amorphous resins of the core but also in the shell and other materials.

It is preferable that the core resin contain a polyester composed of a linear aliphatic alcohol with 2 to 4 carbon atoms and a linear aliphatic acid with 10 to 12 carbon atoms. The linear aliphatic alcohol with 2 to 4 carbon atoms has a carbon number equal to that of ethylene glycol or butanediol derived from commonly recycled resins such as PET or PBT, resulting in high affinity and thus easily exhibiting low-temperature fixability. Additionally, the linear aliphatic acid with 10 to 12 carbon atoms is preferable from the perspective of the thermal properties required for the resin as the toner, handling properties, and cost.

Using terephthalic acid or isophthalic acid derived from recycled polyethylene terephthalate (hereinafter referred to as “PET”) or polybutylene terephthalate (hereinafter referred to as “PBT”) can compensate for the strength of the toner due to the aromatic ring structure of terephthalic acid or isophthalic acid, thus achieving a balance with heat resistance during storage (thermal stability), despite the challenges associated with low-temperature fixing. The effect on environmental consideration is easily recognized as high in the case of a ratio of biomass-derived resin and resin containing terephthalic acid and isophthalic acid in the resin particles of 30 or greater percent by mass.

Furthermore, at a resin ratio of 50 or more percent by mass, the effect on environmental consideration can be significantly enhanced, and the impact on society will be substantial.

The resin particle and toner of the present invention is described in detail below.

It is to be noted that the following embodiments are not limiting the present disclosure and any deletion, addition, modification, change, etc. can be made within a scope in which man in the art can conceive including other embodiments, and any of which is included within the scope of the present disclosure as long as the effect and feature of the present disclosure are demonstrated.

The resin particle of the present invention can be manufactured in the following manner.

### Preparing Oil Phase

The method of manufacturing the resin particle of the present invention includes preparing an oil phase, where components such as a resin, colorant, cross-linking component, and wax are dissolved or dispersed in an organic solvent. Specifically, substances such as resin and a colorant are slowly added to an organic solvent during stirring to dissolve or disperse them in the solvent. For dispersion, known devices such as a bead mill or disk mill can be used.

The materials used in preparing an oil phase are described below.

### Biomass-Derived Resin

Biomass-derived resin refers to resin that includes compounds derived from plants as raw materials and corresponds to biomass-derived resin C in the present invention. Its ratio of alcohol and acid components from petroleum sources and plant sources can be adjusted, balancing the environmental friendliness (compatibility to environment) and toner quality. The content of the biomass resin in the present invention is calculated based on the amount of the monomer used in manufacturing.

An unclear resin monomer composition can be clarified by determining the concentration of carbon-14 and identifying the monomer as follows.

### Concentration of Carbon-14

The concentration of carbon-14 (carbon-14 concentration) of the resin particle relating to an embodiment is 10.8 or more pMC, preferably 11 or more pMC, more preferably 20 or more pMC, and furthermore preferably 30 or more pMC. A carbon-14 concentration below 10.8 pMc is likely to be recognized as a low biomass degree, failing to reduce the environmental burden. The biomass degree is described later.

Carbon-14 is naturally present in the atmosphere; some of it is taken into plants through photosynthesis. Carbon-14 in plants is at equilibrium about concentration (107.5 pMC) with carbon-14 in the atmosphere, carbon is not taken into a plant anymore when the plant ceases to be alive. Then carbon-14 concentration decreases according to the radioactive half life of 5,730 years of carbon-14. Carbon-14 is little detected from fossil resources originating from life forms because several tens of thousands to hundred million years have passed since the live forms died.

The term “pMC” represents percent Modern Carbon, defined as the ratio of C¹⁴ to C¹² in biomass in 1950 being 100 pMC, However, carbon-14 concentration in the atmosphere increases yearly, so the factor for correcting carbon-14 concentration is regulated. Specifically, the correction factor adjusted for each year is used.

Carbon-14 concentration is also represented by the degree of biomass calculated from the following relationship 1.

Degree of biomass (percent)=carbon-14 concentration (pMC)/107.5×100 Relationship 1

A 10.8 or more pMC of carbon-14 concentration represents the degree of biomass is 10 or more percent.

A 10 or more percent of the degree of biomass is adequate from a carbon neutral standpoint.

Measuring carbon-14 concentration is not particularly limited and can be suitably selected to suit to a particular application. Radiocarbon dating is particularly preferable.

The procedure of measuring by radiocarbon dating is to combust resin particles, reducing carbon dioxide (CO₂) to obtain graphite (C). Carbon-14 concentration of graphite is measured by accelerator mass spectroscopy (AMS) analyzer, available from Beta Analytic. This measuring method by AMS is disclosed in Japanese Patent No. 4050051, for example.

### Recycled-Derived Resin

The components derived from recycled resin used in the present invention include PET and PBT as some of the raw materials, which are processed from recycled products. For example, it includes recycled products of PET and PBT processed into flakes, or terephthalic acid, isophthalic acid, and ethylene glycol obtained through chemical recycling. There are no restrictions on the molecular weight distribution, composition, manufacturing method, or form of PET and PBT. The recycle-based resin in the present invention is not limited to recycled resin products. It includes non-commercialized items such as fiber waste and pellets. The ratio of terephthalic acid, isophthalic acid, and ethylene glycol can be adjusted in synthesizing polyester resins, tuning the environmental friendliness and toner quality.

### Amorphous Resin

The amorphous resin is preferably an amorphous polyester resin. Among these, linear polyester resin is preferable and unmodified polyester resin is particularly preferable. Moreover, the environment-friendly resin is preferable.

The unmodified polyester resin is obtained using a polyol with a polycarboxylic acid including polycarboxylic anhydride, polycarboxylic acid ester, and their derivatives. However, it is not modified with a substance such as an isocyanate compound.

Preferably, the amorphous polyester resin is free of a urethane or urea bonding.

### Amorphous Polyester Resin

The amorphous polyester resin contains a dicarboxylic acid component, preferably containing terephthalic acid in an amount of 50 or more mol percent. This proportion is advantageous to enhance the storage stability in high temperature environments, or thermal resistance during storage.

One such polyol is a diol.

Specific examples of diol includes, but are not limited to, an adduct of bisphenol A with alkylene (having two or three carbon atoms) oxide (average adduction mol number of from 1 to 10) such as polyoxypropylene(2,2)-2,2-bis(4-hydroxyphenyl)propane, polyoxyethylene(2,2)-2,2-bis(4-hydroxyphenyl)propane, ethylene glycol, propylene glycol, hydrogenated bisphenol A, and an adduct of hydrogenated bisphenol A with an alkylene (having two or three carbon atoms) oxide (average adduction mol number of from 1 to 10).

These can be used alone or in combination.

One specific example of the polycarboxylic acid is dicarboxylic acid.

Specific examples of dicarboxylic acid include, but are not limited to, adipic acid, phthalic acid, isophthalic acid, terephthalic acid, fumaric acid, maleic acid, and succinic acid substituted with an alkyl group having 1 to 20 carbon atoms or alkenyl group having 2 to 20 carbon atoms such as dodecenyl succinic acid and octyl succinic acid.

Of these, dicarboxylic acid containing a plant-derived succinic acid of saturated aliphatic series is preferable.

The level of carbon neutral becomes high because of its being plant-origin. An effect of saturated aliphatic compounds is promoting recrystallization of crystalline polyester resins, leading to an increase in the aspect ratio, resulting in enhanced ability to fix at low temperatures.

These can be used alone or in combination.

The amorphous polyester resin B mentioned above may optionally contain at least either a tri- or higher carboxylic acid and a tri- or higher alcohol to adjust the acid value and hydroxyl values.

Specific examples of tri- or higher carboxylic acid include, but are not limited to, trimellitic acid, pyromellitic acid, and their anhydrides.

Specific examples of tri- or higher alcohol include, but are not limited to, glycerin, pentaerythritol, and trimethylol propane.

### Amorphous Polyester Resin B

The amorphous polyester resin B for use in the present invention are preferably obtained by using a plant-derived alcohol component and an acid component to adjust the environmental compatibility ratio. Simultaneously, it is preferable to use polyester resins synthesized from terephthalic acid, isophthalic acid, and ethylene glycol derived from PET and/or PBT. Additionally, the amorphous polyester resin B contains a structural unit derived from terephthalic acid and a structural unit derived from isophthalic acid with a preferable proportion to the structural unit derived from terephthalic acid of 1 or greater percent.

As the plant-derived alcohol component, using ethylene glycol or propylene glycol as the alcohol component and terephthalic acid or succinic acid as the acid component is preferable. However, the plant-derived components are not particularly limited to those above-mentioned. Any plant-derived is usable.

The molecular weight of the amorphous polyester resin B is not particularly limited and can be suitably selected to suit to a particular application. The weight average molecular weight Mw is preferably from 3,000 to 10,000 as measured by gel permeation chromatography (GPC). The number average molecular weight Mn is preferably from 1,000 to 4,000. The ratio Mw/Mn is preferably from 1.0 to 4.0.

A molecular weight not lower than the lower limit mentioned above prevents the toner's storage stability in high-temperature environments and durability under stress such as stirring in a developing device from decreasing. A molecular weight up to the upper limit mentioned above prevents the toner's viscoelasticity from increasing during the melting process and prevents weakening of its low-temperature fixability.

The weight average molecular weight Mw is more preferably from 4,000 to 7,000. The number average molecular weight Mn is more preferably from 1,500 to 3,000. The ratio of Mw/Mn is more preferably from 1.0 to 3.5.

The acid value of the amorphous polyester resin B has no particular limit and can be suitably selected to suit to a particular application. A range of 1 to 50 mg KOH/g is preferable, with 5 to 30 mg KOH/g being even more favorable. An acid value of not lower than 1 mgKOH/g tends to negatively charge a toner and enhances the affinity between paper and the toner during fixing on the paper, enhancing the low temperature fixability. An acid value of not greater than 50 mgKOH/g prevents the charging stability, particularly charging stability to environmental fluctuation, from deteriorating.

The hydroxyl value of the amorphous polyester resin B is not particularly limited and can be suitably selected to suit to a particular application. The value is preferably not less than 5 mgKOH/g.

The glass transition temperature Tg of the amorphous polyester resin B is preferably from 40 to 80 degrees Celsius and more preferably from 50 to 70 degrees Celsius. A glass transition temperature of not lower than 40 degrees Celsius enhances the high temperature storage stability (storage stability in high temperature environments) and the durability to stress such as stirring in a developing device while enhancing resistance to filming. A glass transition temperature of not high than 80 degrees Celsius suitably deforms the shape of toner under heat and pressure during fixing, thereby enhancing low temperature fixability.

The molecular structure of the amorphous polyester resin B can be analyzed in solution or solid state using nuclear magnetic resonance (NMR), along with other methods such as X-ray diffraction, Gas Chromatography-Mass spectrometry (GC/MS), Liquid Chromatograph-Mass Spectrometry (LC/MS), and infrared (IR) absorption. A simple method of detecting an amorphous polyester resin involves identifying substances that exhibit absorption based on the δCH (out-of-plane vending vibration) of olefins at 965 cm⁻¹±10 cm⁻¹ or 990 cm⁻¹±10 cm⁻¹ in the infrared absorption spectrum as amorphous polyester resin.

The proportion of the amorphous polyester resin B is not particularly limited and can be suitably selected to suit to a particular application. The number of parts of the amorphous polyester resin B is preferably from 50 to 90 parts by mass and more preferably from 60 to 80 parts by mass to 100 parts by mass of the toner mentioned above. Fifty or more parts by mass reduces the degree of degradation of the dispersibility of the pigment and release agent in the toner and minimizes image fogging and disturbance of an image. A number of parts of 90 or less parts by mass prevents a decrease in the content of the polyester resin C and that of the other polyester resin (hereinafter also referred to as amorphous polyester resin A) and deterioration of the low temperature fixability.

The content in the more preferable region specified above is advantageous for achieving excellent image quality and low temperature fixability.

### Polyester Resin C

The polyester resin C used in the present invention is described in detail below.

The polyester resin C has a high crystallinity, thereby exhibiting a heat-melt property demonstrating a sharp change in viscosity around the fixing starting temperature.

A combinational use of such polyester resin C with the amorphous polyester resin B affords a toner with good high temperature storage stability and low temperature fixability.

Specifically, this combination demonstrates good high temperature storage stability due to the crystallinity up to nearly the melting onset temperature. At the melting onset, the sharp drop in viscosity (sharp melting property) occurs due to the melting of the crystalline polyester resin C. At this point, the crystalline polyester resin C becomes compatible with the amorphous polyester resin B, causing a sharp viscosity drop in both resins, resulting in good fixability.

Crystalline polyester resin can be prepared by a polyol with a polycarboxylic acid including a polycarboxylic anhydride and polycarboxylic acid ester or their derivatives. In the present invention, the crystalline polyester resin refers to a substance obtained by using a polyol and a polycarboxylic acid including a polycarboxylic anhydride and polycarboxylic acid ester or their derivatives as described above. The crystalline polyester resin excludes modified polyester resin obtained by a prepolymer and resin obtained by cross-linking and/or elongating the prepolymer.

### Polyhydric Alcohol

As the polyhydric alcohol, a linear saturated aliphatic diol with 2 to 4 carbon atoms is preferred. A branched-type saturated aliphatic diol may diminish the crystallinity of the crystalline polyester resin, thereby lowering its melting point.

Some examples of the linear saturated aliphatic diol include ethylene glycol, 1,3-propanediol, and 1,4-butanediol. Of these, ethylene glycol and 1,4-butanediol are preferred due to their high crystallinity and excellent sharp melting characteristics in the crystalline polyester resin. These may be used alone or in a combination of two or more thereof.

### Polycarboxylic Acid

As the polycarboxylic acid, a linear saturated aliphatic acid with 10 to 12 carbon atoms is preferred. Some examples of such polycarboxylic acids are saturated aliphatic dicarboxylic acids like 1,10-decanedicarboxylic acid and 1,12-dodecanedicarboxylic acid.

Of these, plant-derived saturated aliphatic having 12 or less carbon atoms is preferable from a carbon neutral point of view. These may be used alone or in a combination of two or more thereof.

The polyester resin C is preferably formed of a straight chain saturated aliphatic diol with 2 to 4 carbon atoms and a linear saturated aliphatic dicarboxylic acid with 10 to 12 carbon atoms. This polyester resin thus demonstrates high crystallinity and excellent sharp melting, thereby achieving excellent low temperature fixability.

One way of controlling the crystallinity and the softening point of the crystalline polyester resin is to design and use a non-linear polyester obtained through polycondensation. During polyester synthesis, this involves adding a polyol, such as a tri- or higher alcohol like glycerin, to the alcohol component, and a polycarboxylic acid, such as a tri- or higher carboxylic acid like trimellitic anhydride, to the acid component.

The molecular structure of the polyester resin C in the present invention can be analyzed by measuring a solution or solid by methods such as NMR, X ray diffraction, GC/MS, LC/MS, and infrared (IR) absorption measuring.

The crystalline polyester resin C can be simply detected as a substance that has absorption in a range of 965±10 cm⁻¹ and 990±cm⁻¹ based on δCH (out of plane bending vibration) of olefin in an infrared absorption spectrum.

Based on the knowledge about the molecular weight that a resin with a low molecular weight and a sharp molecular weight distribution has good low temperature fixability, and a resin containing a component with a small molecular weight in a large amount has a poor high temperature storage stability, the inventors of the present invention have identified that the molecular weight of the polyester resin C preferably has a peak in a range of from 3.5 to 4.0, a peak half width value of 1.5 or less, a weight average molecular weight Mw of from 3,000 to 30,000, a number average molecular weight Mn of from 1,000 to 10,000, and an Mw/Mn of from 1 to 10 in the graph of the molecular weight distribution represented by log (M) on the X-axis and percent by mass on the Y-axis, obtained through GPC of the portion soluble in o-dichlorobenzene.

The weight average molecular weight Mw is more preferably from 5,000 to 15,000, the number average molecular weight Mn is more preferably from 2,000 to 10,000, and the ratio of Mw/Mn is more preferably from 1 to 5.

The acid value of the crystalline polyester resin is preferably 5 or more mgKOH/g to achieve a target low temperature fixability in terms of the affinity between paper and resin and more preferably 7 or more mgKOH/g to manufacture fine particles by a phase transition emulsification. On the other hand, it is preferably 45 or less mgKOH/g to enhance the hot offset property. The hydroxyl value of a crystalline polymer is preferably from 0 to 50 mgKOH/g and more preferably from 5 to 50 mgKOH/g to achieve a target low temperature fixability and good chargeability.

### Colorant

The suitable colorant (coloring material) in the present invention includes known dyes and pigments.

Specific examples include, but are not limited to, carbon black, Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Faise Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone BlueFast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials can be used alone or in combination.

### Organic Solvent

As the organic solvent, an organic solvent with a boiling point below 100 degrees Celsius is preferred for ease of subsequent solvent removal.

Specific examples of the organic solvent include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methylethyl ketone, methylisobuthyl ketone, methanol, ethanol, and isopropyl alcohol. These can be used alone or in combination. A resin with a polyester backbone is well dissolved or dispersed in an organic solvent such as ester-based solvents including methyl acetate, ethyl acetate, and butyl acetate or ketone-based solvents including methylethyl ketone and methyl isobutyl ketone. Of these, methyl acetate, ethyl acetate, and methyl ethyl ketone are particularly preferable to readily purge the organic solvent of a solution or dispersion.

### Prepolymer

The resin particle of the present invention may furthermore optionally contain a prepolymer.

One of the prepolymers—reactive precursors—is a polyester with a group reactive with an active hydrogen group.

Specific examples of the group reactive with an active hydrogen group include, but are not limited to, an isocyanate group, an epoxy group, a carboxylic acid, and an acid chloride group. Of these, an isocyanate group is preferable to introduce a urethane or urea bond into an amorphous polyester resin.

The reactive precursor may have a branched structure due to the presence of at least one of tri- or higher alcohol and tri- or higher carboxylic acid.

One example of the polyester resin containing an isocyanate group is a reaction product of a polyisocyanate and a polyester resin with an active hydrogen group. One way of obtaining a polyester resin with an active hydrogen group involves polycondensing a diol with a dicarboxylic acid or, or polycondensing a tri- or higher alcohol with a tri- or higher carboxylic acid. Polycondensation of a tri- or higher alcohol and a tri- or higher carboxylic acid results in a branch-structured polyester resin with an isocyanate group.

Specific examples of the diols include, but are not limited to, aliphatic diols such as ethylene glycol, 1,2-propylene glycol, 1,3-propylene glycol, 1,4-butanediol, 2-methyl-1,3-propanediol, 1,5-pentanediol, 3-methyl-1,5-pentanediol, 1,6-hexanediol, 1,8-octanediol, 1,10-decanediol and 1,12-dodecanediol, diols having oxyalkylene groups such as diethylene glycol, triethylene glycol, dipropylene glycol, polyethylene glycol, polypropylene glycol and polytetramethylene glycol; diols having oxyalkylene groups such as diethylene glycol, triethylene glycol, dipropylene glycol, polyethylene glycol, polypropylene glycol and polytetramethylene ether glycol; alicyclic diols such as 1,4-cyclohexane dimethanol and hydrogenated bisphenol A; adducts of alicyclic diols with an alkylene oxide such as ethylene oxide, propylene oxide, and butylene oxide; bisphenols such as bisphenol A, bisphenol F, and bisphenol S; and adducts of bisphenols with an alkylene oxide such as ethylene oxide, propylene oxide, and butylene oxide. Of these, aliphatic diols having 3 to 10 carbon atoms such as 1,2-propylene glycol, 1,3-propylene glycol, 1,4-butanediol, 2-methyl-1,3-propanediol, 1,5-pentanediol, and 3-methyl-1,5-pentanediol are preferable to adjust the glass transition temperature of the polyester resin (A) to 20 degrees Celsius or lower. Using these aliphatic diol at a proportion of 50 percent by mol or greater to the alcohol components in a resin is more preferable. These diols can be used alone or in combination.

The polyester resin A is preferably amorphous, and introducing steric hindrance to the resin chains reduces the melt viscosity during fixing, thereby enhancing low-temperature fixability. Therefore, it is preferable for the main chain of the aliphatic diol to have the structure represented by the following Chemical Formula 1.

HO— [symbol] CR₁R₂ [symbol] ₙOH Chemical Formula 1

In Chemical Formula 1, R₁ and R₂ each independently represent hydrogen atoms or alkyl groups with 1 to 3 carbon atoms and n represents an odd integer of from 3 to 9. R₁ and R₂ each independently can be the same or different in the n repeating units.

The main chain of an aliphatic diol in the present invention refers to the carbon chain linked between the two hydroxy groups of the aliphatic diol by the minimal number. The number of carbon atoms in the main chain is preferably an odd number because crystallinity is negatively affected by an even number. In addition, aliphatic diol with at least one alkyl group having 1 to 3 carbon atoms in the side chain is preferable, which decreases the mutual action energy between the molecules in the main chain because of steric conformation.

Specific examples of the dicarboxylic acids include, but are not limited to, aliphatic dicarboxylic acids such as succinic acid, adipic acid, sebacic acid, dodecanedioic acid, maleic acid, and fumaric acid and aromatic dicarboxylic acids such as phthalic acid, isophthalic acid, terephthalic acid, naphthalene dicarboxylic acids. In addition, their anhydrides, lower (i.e., 1 to 3 carbon atoms) alkyl esterified compound, and halogenated compounds can be used. Of these, aliphatic dicarboxylic acid with 4 to 12 carbon atoms is preferable to achieve a glass transition temperature Tg of a polyester resin of 20 or lower degrees Celsius. Using 50 or more percent by mass of the carboxylic acid component in a resin is more preferable. These dicarboxylic acids can be used alone or in combination.

Specific examples of tri- or higher alcohols include, but are not limited to, tri- or higher aliphatic alcohols such as glycerin, trimethylolethane, trimethylolpropane, pentaerythritol, and sorbitol; tri- or higher polyphenols such as trisphenol PA, phenol novolac, and cresol novolac; and adducts of alkylene oxide such as ethylene oxide, propylene oxide, and butylene oxide with trihydric or higher polyphenols.

One example of tri or higher carboxylic acids is a tri- or higher aromatic carboxylic acid. Of these, tri- or higher aromatic carboxylic acids with 9 to 20 carbon atoms such as trimellitic acid and pyromellitic acid are particularly preferable. In addition, their anhydrides, lower (i.e., 1 to 3 carbon atoms) alkyl esterified compounds, and halogenated compounds can be used.

Examples of the polyisocyanate include, but are not limited to, diisocyanate and tri- or higher isocyanate.

The polyisocyanate is not particularly limited and can be suitably selected to suit to a particular application.

Specific examples include, but are not limited to, aromatic diisocyanates such as either or both of 1,3- and 1,4-phenylene diisocyanate, of 2,4- and 2,6-tolylene diisocyanate (TDI), of crude TDI, of 2,4′- and 4,4′-diphenyl methane diisocyanate (MDI), and of crude MDI [phosgenated compounds of crude diamonophenyl methane (condensed product of formaldehyde and aromatic amine (aniline) or with a their mixture; a mixture of diaminodiphenyl methane and a small amount (e.g., 5 to 20 percent by mass) of tri- or higher polyamine]:polyallyl polyisocyanate (PAPI)], 1,5-naphtylene didsocyanate, 4,4′,4″-triphenylmethane triisocyanate, m- and p-isochyanato phenylsupphonyl isocyanate;
aliphatic diisocyanates such as ethylene diisocyanate, tetramethylene diisocyanate, hexamethylene diisocyanate (HDI), dodecamethylene diisocyanate, 1,6,11-undecane triisocyanate, 2,2,4-trimethylhexamethylene diisocyanate, lysine diisocyanate, 2,6-diisocyanatomethyl caproate, bis(2-isocyanatoethyl) fumarate, bis(2-isocyanatoethyl) carbonate, and 2-isocyanatoethyl-2,6-diisocyanatohexanoate; alicyclic diisocyanates such as isophorone diisocyanate (IPDI), dicyclohexylmethane-4,4′-diisocyanate (hydrogenated MDI), cyclohexylene diisocyanate, methylcyclohexylene diisocyanate (hydrogenated TDI), bis(2-isocyanatoethyl)-4-cyclohexene-1,2-dicarboxylate and 2,5- and 2,6-norbornane diisocyanate; aromatic aliphatic diisocyanates such as m- and p-xylylene diisocyanate (XDI) and α,α,α′,α′-tetramethylxylylene diisocyanate (TMXDI); tri- or higher polyisocyanates such as lysine triisocyanate and diisocyanate modified products of tri- or higher alcohols; and modified products of these isocyanates. Mixtures of two or more types mentioned above can be used.

Specific examples of the modified products of isocyanate include, but are not limited to, modified compounds having a urethane group, a carbodiimide group, an allophanate group, a urea group, a biuret group, a uretdione group, a uretonimine group, an isocyanulate group, or an oxazoline group.

The oil phase may contain additives such as a charge control agent.

### Charge Control Agent

Specific examples of the charge control agent include, but are not limited to, known charge control agents such as Nigrosine dyes, triphenylmethane dyes, metal complex dyes including chromium, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid, and metal salts of salicylic acid derivatives. Specific examples of the procurable charge control agent include, but are not limited to, BONTRON 03 (Nigrosine dyes), BONTRON P-51 (quaternary ammonium salt), BONTRON S-34 (metal-containing azo dye), E-82 (metal complex of oxynaphthoic acid), E-84 (metal complex of salicylic acid), and E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative), COPY CHARGE NEG VP2036 and NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments and polymers having a functional group such as a sulfonate group, a carboxyl group, and a quaternary ammonium group. The charge control agent is used in an amount within a range where it demonstrates its capability without adversely impacting fixability. Its proportion in the toner is preferably from 0.5 to 5 percent by mass and more preferably from 0.8 to 3 percent by mass.

### Wax

Wax is not particularly limited and can be suitably selected to suit to a particular application. For example, a release agent with a low melting point of from 50 to 120 degrees Celsius is preferable. A release agent with a low melting point efficiently works at the interface between a fixing roller and the toner when dispersed with the resin mentioned above. For this reason, hot offset resistance becomes good even in an oil-free configuration, in which a release agent like oil is not applied to a fixing roller.

The release agent preferably includes waxes.

Specific examples of such waxes include, but are not limited to, natural waxes including: vegetable waxes such as carnauba wax, cotton wax, Japan wax, and rice wax; animal waxes such as bee wax and lanolin; mineral waxes such as ozokerite; and petroleum waxes such as paraffin, microcrystalline, and petrolatum. In addition to these natural waxes, synthesis hydrocarbon waxes such as Fischer-Tropsch wax and polyethylene wax and synthesis wax such as ester, ketone, and ether are also usable. Furthermore, fatty acid amide such as 12-hydroxystearic acid amide, stearic acid amide, phthalic acid anhydride imide, and chlorinated hydrocarbons; crystalline polymer resins having a low molecular weight such as homo polymers, for example, poly-n-stearylic methacrylate and poly-n-lauryl methacrylate, and copolymers (for example, copolymers of n-stearyl acrylate-ethylmethacrylate); and crystalline polymer having a long alkyl group in the branched chain are also usable. These can be used alone or in combination.

Plant-derived wax is preferable to reduce the environmental burden.

The melting point of wax is not particularly limited and can be suitably selected to suit to a particular application. The melting point is preferably from 50 to 120 degrees Celsius and more preferably from 60 to 90 degrees Celsius. A melting point of the ester wax of 50 or higher prevents adverse impacts on the high temperature storage stability, while a melting point of 120 or lower degrees Celsius prevents cold offset during low-temperature fixing. The melt-viscosity of wax is preferably from 5 cps to 1,000 cps and more preferably from 10 cps to 100 cps at a temperature 20 degrees Celsius higher than the melting point of the wax (release agent). A melt viscosity of 5 or more cps prevents a decrease in releasability, while a melt viscosity of 1,000 or less cps is sufficient to demonstrate resistance to hot offset, as well as low-temperature fixability. The proportion of wax to the toner mentioned above is not particularly limited and can be suitably selected to suit to a particular application. For example, it is preferably from 0 to 40 percent by mass and more preferably from 3 to 30 percent by mass.

### Method of Manufacturing Resin Particle

The method of manufacturing the resin particle of a present embodiment is described below. The method of manufacturing the resin particle of an embodiment includes preparing an oil phase, preparing an aqueous phase, phase inversion emulsifying, solvent-removing, aggregating, and fusing. The method may include other optional processes such as shelling, rinsing, drying, annealing, and adding an external additive.

### Preparing Oil Phase

In preparing an oil phase, feedstock of the resin particle including resin (amorphous and crystalline resin) and other optional materials such as a colorant, polymers (precursors of amorphous polyester resin A), and wax are dissolved or dispersed in an organic solvent. Some of these optional materials can be added during aggregating described later.

The method of preparing the oil phase is not particularly limited and can be selected to suit to a particular application. One way of preparing is to gradually add raw materials such as resin to an organic solvent during stirring to dissolve or disperse them.

For dispersion, known dispersers such as a bead mill or disk mill can be used.

Each of the materials in preparing an oil phase can be the same as that mentioned in Resin Particle. These can be used alone or in combination. At least one of the resins (amorphous resin and crystalline resin) is preferably a biomass-derived resin.

The organic solvent is not particularly limited and can be suitably selected to suit to a particular application. It is preferably a volatile solvent having a boiling point of lower than 100 degrees Celsius to remove the organic solvent later.

Specific examples of the organic solvent include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, butyl acetate, methylethyl ketone, methylisobuthyl ketone, methanol, ethanol, and isopropyl alcohol. These can be used alone or in combination.

A resin with a polyester backbone is preferable to dissolve or disperse it in an organic solvent such as ester-based solvents including methyl acetate, ethyl acetate, and butyl acetate or ketone-based solvents including methylethyl ketone and methyl isobutyl ketone to achieve high solubility. Of these, methyl acetate, ethyl acetate, and methyl ethyl ketone are particularly preferable as organic solvents to easily purge a dispersion of the organic solvent later.

The proportion of the organic solvent has no particular limit and can be suitably selected to suit to a particular application. For example, the proportion is preferably from 40 to 300 parts by mass, more preferably from 60 to 140 parts by mass, and furthermore preferably from 80 to 120 parts by mass to 100 parts by mass of the raw materials of a resin particle.

### Preparing Aqueous Phase

An aqueous phase (aqueous medium) is prepared in the process of preparing an aqueous phase. The aqueous medium is not particularly limited and can be suitably selected among known media to suit to a particular application. It includes, for example, water, a solvent miscible with water, and a mixture thereof. The concentration of an organic solvent is preferably not greater than the saturation concentration to deionized water in terms of granularity.

The solvent miscible with water is not particularly limited and can be suitably selected among known solvents to suit to a particular application. It includes, for example, alcohol, dimethyl formamide, tetrahydrofuran, cellosolves, lower ketones, and esters.

Specific examples of the alcohols include, but are not limited to, methanol, isopropanol, and ethylene glycol.

Specific examples of the lower ketones include, but are not limited to, acetone and methyl ethyl ketone.

A specific example of the esters is ethyl acetate.

These can be used alone or in combination.

### Phase Transition Emulsification

The oil phase obtained in preparing an oil phase is atomized in the phase transition emulsification process.

After the oil phase is neutralized, deionized water is added to the neutralized oil phase to carry out emulsification by phase transition from the water-in-oil liquid dispersion to an oil-in-water liquid dispersion, thus obtaining an atomized liquid dispersion.

Phase transition emulsification is conducted by agitation.

This phase transition emulsification is carried out with a typical stirrer or disperser during uniform mixing and dispersing.

The stirring blade is not particularly limited and can be suitably selected according to viscosity of a solution. Examples thereof include, but are not limited to, low-viscosity stirring blades such as a paddle and a propeller, medium-viscosity stirring blades such as an anchor and a maxblend, and high-viscosity stirring blades such as a helical ribbon. The disperser is not particularly limited. It includes, but it not limited to, an ultrasonic dispersing machine, a bead mill, a ball mill, a roll mill, a homomixer, an ultramixer, a dispersion mixer, a penetration-type high-pressure dispersing machine, a collision-type high-pressure dispersing machine, a porous-type high-pressure dispersing machine, an ultrahigh-pressure homogenizer, and an ultrasonic homogenizer. Typical stirrers can be used together with a disperser.

Of these, paddles and anchors are preferable to adjust the volume average particle diameter of a dispersion (oil droplet) to the preferable range mentioned above.

As the base for neutralizing the oil phase, any of a basic inorganic compound and a basic organic compound can be used.

Specific examples of the basic inorganic compound include, but are not limited to, sodium hydroxide, potassium hydroxide, lithium hydroxide, ammonia, sodium carbonate, sodium hydrogen carbonate, potassium carbonate, potassium hydrogen carbonate, and ammonia. Specific examples of the basic organic compound include, but are not limited to, N,N-dimethylethanolamine, N,N-diethylethanolamine, triethanolamine, tripropanolamine, tributanolamine, triethylamine, n-propylamine, n-butylamine, isopropylamine, monomethanolamine, morpholine, methoxypropylamine, pyridine, vinylpyridine, and isophoronediamine.

In the case of a stirring blade, conditions such as the number of rotations, stirring time, and stirring temperature are not particularly limited and can be suitably selected to suit to a particular application.

The number of rotations is not particularly limited and preferably 100 to 1,000 rotation per minute (rpm) and more preferably from 200 to 600 rpm.

The stirring time and the stirring temperature are not particularly limited and can be suitably selected to suit to a particular application.

Optionally, it is possible to use a dispersant. The dispersant is not particularly limited and any known dispersion agent can be suitably used.

Specific examples include, but are not limited to, surfactants, inorganic compound dispersants sparingly soluble in water, and polymeric protective colloids. These can be used alone or in combination. Of these, surfactants are preferable.

The surfactant mentioned above has no particular limit and can be suitably selected to suit to a particular application. For example, anionic surfactants, nonionic surfactants, cationic surfactants, and amphoteric surfactants are usable.

The anionic surfactant is not particularly limited and can be suitably selected to suit to a particular application.

Specific examples include, but are not limited to, alkylbenzene sulfonates, α-olefin sulfonates, and phosphate esters. Of these, compounds having a fluoroalkyl group are preferable.

### Removal of Solvent

One way of removing the organic solvent from the thus-prepared liquid dispersion of colored fine particles is to gradually raise the temperature of the entire system during stirring to completely evaporate and remove the organic solvent in liquid droplets.

Another approach involves spraying the liquid dispersion of colored fine particles in a dried atmosphere during stirring to ensure the complete removal of the organic solvent in droplets. Alternatively, it is possible to evaporate and remove an organic solvent under a reduced pressure while stirring the liquid dispersion of colored fine particles. The latter two methods can be employed in conjunction with the first one.

Various gases such as air, nitrogen, carbon dioxide, heated gases including combustion gases, and gases heated to temperatures at or exceeding the boiling point of the highest boiling point solvent employed are commonly used as the drying atmosphere for spraying the liquid dispersion of colored fine particles. The drying treatment in a short period of time with a drying device such as a spray dryer, a belt dryer, a rotary kiln, etc. is sufficient to obtain desired quality.

The liquid dispersion of colored fine particles is obtained by the methods described above.

### Aggregation

Next, the liquid dispersion of colored fine particles obtained is agitated to obtain aggregated particles with a target particle size.

For aggregation, a known method is employed such as adding a flocculant and adjusting pH. While the flocculant can be added directly, it is preferable to use an aqueous solution containing the flocculant to avoid local high concentrations. In addition, it is preferable to slowly add an aggregated salt while the particle diameter of a colored particle is monitored.

It is preferable for the temperature of the liquid dispersion during aggregation to be close to the glass transition temperature (Tg) of the resin being used. If the liquid temperature is too low, it can impede efficient aggregation progress. Conversely, excessively high temperatures can accelerate aggregation, leading to the formation of coarse particles and a deterioration in particle size distribution.

Once the target particle size is achieved, the aggregation process is halted. Methods to cease aggregation include adding salts with low ionic valency or chelating agents, adjusting the pH, lowering the temperature of the liquid dispersion, and adding a significant amount of aqueous medium to dilute the concentration.

By the methods described above, the liquid dispersion containing a colored aggregated particles is obtained.

In the aggregation, wax can be added as a release agent. In such a case, aggregated particles in which wax or a crystalline resin are uniformly dispersed are obtained by aggregating a liquid dispersion in which wax is dispersed in an aqueous medium or after mixing with the liquid dispersion of colored fine particles.

### Flocculant

Any known flocculant can be used. Examples include, but are not limited to, metal salts of monovalent metals such as sodium and potassium, metal salts of divalent metals such as calcium and magnesium, and metal salts of trivalent metals such as iron and aluminum.

### Processes of Ceasing and Fusing

The aggregated particles obtained are fused by heating to reduce the roughness of the particles, thus obtaining spheroidized particles. To fuse the aggregated particles, the liquid dispersion of the colored aggregated particle is heated during stirring. The temperature of the liquid is preferably around a little above the glass transition temperature Tg of the resin being used.

### Shell Forming

A shell layer is formed around the spheroidized particle obtained during fusing.

There is no specific limitation to the method of forming a shell layer and any method known in the art can be suitably selected to suit to a particular application. One way of forming a shell layer is to prepare a spheroidized particle with a target particle size during fusing, add an amorphous resin to the particle, and then repeat the processes of aggregation and fusing.

### Rinsing and Drying

The liquid dispersion of toner particle obtained by the method described above contains auxiliary materials such as aggregated salts other than the toner particles. The liquid dispersion should thus be rinsed to extract the toner particles alone. A method such as centrifugation, filtering under reduced pressure, or filter pressing can be employed to rinse the toner particle. The method is not particularly limited in the present invention. Regardless of the method used, a toner particle cake is obtained. If more than one rinsing operation is required, the cake obtained can be repeatedly dispersed in an aqueous medium to produce a slurry, from which resin particles are extracted using one of the above-mentioned methods. Alternatively, if vacuum filtration or filter pressing is employed, auxiliary materials held in the colored toner particles can be rinsed by a passage of an aqueous medium through the cake. The aqueous medium used for rinsing is either water or a solvent mixture of water with alcohols such as methanol or ethanol. To reduce the cost and the environmental burden, water is preferable.

Since the rinsed toner particles retain a considerable amount of aqueous medium inside, the aqueous medium is removed by drying to obtain toner particles alone. In the drying method, it is possible to use a drier such as a drier, vacuum freeze drier, vacuum drier, ventilation rack drier, mobile rack drier, fluid bed drier, rotary drier, and stirring drier. Preferably, the dried toner particle is further dried until the moisture in the particle is less than 1 percent. The dried colored resin particles agglomerate softly. If this softly-aggregated particle is not convenient for use, it is suitable to pulverize it with a device such as a jet mill, Henschel mixer, super mixer, coffee mill, Oster blender, and food processor to loosen it.

### Annealing

If a crystalline resin is added in the aggregation, the aggregated resin is subjected to annealing after drying to phase-separate the amorphous resin from the crystalline resin, thereby enhancing the fixability. Specifically, the resin annealed is stored at around the Tg for 10 or more hours.

### External Additive Treatment

Additives such as inorganic fine particles, fine polymer particles, and a cleaning improver can be added to or mixed with the toner particle obtained in an embodiment of the present invention to impart flowability, chargeability, and cleaning property.

Specific examples of such mixing methods include, but are not limited to, a method in which an impact is applied to a mixture with a blade rotating at a high speed and a method in which a mixture is put into a jet air to collide particles against each other or complex particles to a suitable collision plate. Specific examples of mixing devices include, but are not limited to, ONG MILL (available from Hosokawa Micron Co., Ltd.), modified I TYPE MILL in which the pressure of air used for pulverizing is reduced (available from Nippon Pneumatic Mfg. Co., Ltd.), HYBRIDIZATION SYSTEM (available from Nara Machine Co., Ltd.), KRYPTRON SYSTEM (available from Kawasaki Heavy Industries, Ltd.), and automatic mortars.

### External Additive

The inorganic fine particle preferably has a primary particle diameter of from 5 nm to 2 μm, and more preferably from 5 nm to 500 nm. In addition, it is preferable that the specific surface as measured by BET method be 20 to 500 m²/g. The proportion of this inorganic fine particle to a toner is preferably from 0.01 to 5 percent by mass.

Specific examples of such inorganic fine particles include, but are not limited to, silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, and silicon nitride.

The polymeric fine particles include, but are not limited to, polystyrene, methacrylates, and acrylates obtained by soap-free emulsion polymerization, suspension polymerization, or dispersion polymerization, and polycondensed particles such as silicone, benzoguanamine, and nylon, and polymer particles of thermocuring resin.

The external additive such as a fluidizer can be hydrophobized by surface treatment to enhance the hydrophobicity and prevent the deterioration of the fluidity and chargeability in a high humidity environment. Preferred specific examples of surface treatment agents include, but are not limited to, silane coupling agents, silyl agents, silane coupling agents having a fluorine alkyl group, organic titanate coupling agents, aluminum-based coupling agents, silicone oil, and modified-silicone oil.

Cleaning improvers are used to remove the developing agent remaining on an image bearer such as a photoconductor and a primary transfer body.

Specific examples include, but are not limited to, zinc stearate, calcium stearate and metal salts of fatty acid acids such as stearic acid and polymeric fine particles such as polymethyl methacrylate fine particles and polystyrene fine particles, which are prepared by a method such as soap-free emulsion polymerization. Such polymeric fine particles preferably have a relatively sharp particle size distribution and a volume average particle size of from 0.01 to 1 μm.

The resin particle of the present embodiment has properties as described above, so it can be used as a material for image forming such as a toner, a developing agent, a toner set, a toner accommodating unit, and an image forming apparatus.

### Toner

The toner of a present embodiment of the present invention contains the resin particle relating to the embodiment and can be formed of the resin particle relating to the embodiment.

Using the resin particle of the embodiment for a toner reduces environmental burden and demonstrates excellent low temperature fixability and chargeability even with a plant-derived resin. The resin can thus provide images with excellent image quality.

### Developing Agent

The developing agent of an embodiment of the present invention contains the toner relating to one embodiment of the present invention and other optional components such as a carrier. The developing agent can thus stably form quality images with excellent transfer properties and chargeability.

The developing agent can be a one-component or two-component developing agent. A two-component developing agent is preferable for a high-performance printer that supports high speed information processing of late to enjoy a longer working life.

As for the toner relating to an embodiment of the present invention used as a one-component development, the toner particle size almost never changes upon toner replenishment. Due to this stable toner particle size, the toner is less likely to form a film on the developing roller and fusion-bond on the members such as a blade for regulating the thickness of the toner layer. The toner can thus produce quality images with good and stable developability even after agitating in the developing device for an extended period of time.

The toner relating to an embodiment of the present invention used as a two-component developing agent can be mixed with a carrier. As for the toner according to an embodiment of the present invention used as a two-component development, the toner particle size does not vary upon toner replenishments for an extended period of time. Due to this stable toner particle size, the toner can thus produce quality images with good and stable developability even after the toner is agitated in the developing device for an extended period of time.

The content of the carrier in a two-component developing agent can be suitably selected to suit to a particular application. The content is preferably from 90 to 98 parts by mass and more preferably from 93 to 97 parts by mass to 100 parts of a two-component developing agent.

The developing agent of the present embodiment can be suitably used for image formation by various known electrophotography such as a magnetic one-component developing method, a non-magnetic one-component developing method, and a two-component developing method.

### Carrier

The carrier is not particularly limited and can be suitably selected to suit to a particular application. Preferably, a carrier contains a core material and a resin layer (cover layer) covering the core material.

### Core Material

The material of the core material is not particularly limited and can be suitably selected to suit to a particular application.

Specific examples include, but are not limited to, a manganese-strontium-based material of from 50 to 90 emu/g and a manganese-magnesium-based material of from 50 to 90 emu/g. To achieve a suitable image density, using a high magnetized material such as powdered iron not less than 100 emu/g and magnetite from 75 to 120 emu/g is preferable. Low magnetized materials such as copper-zinc based material having 30 to 80 emu/g are preferable because it can reduce an impact of the developing agent in a filament state on a photoconductor and is advantageous to enhance the image quality. These can be used alone or in combination.

The volume average particle diameter of the core material is not particularly limited and can be suitably selected to suit to a particular application. For example, the volume average particle diameter is 10 to 150 μm and more preferably 40 to 100 μm. A volume average particle diameter of 10 or more μm does not cause a problem of increasing fine carrier with low magnetization per particle, resulting in scattering of the carrier. Conversely, a volume average particle diameter of 150 or less μm prevents a problem of toner scattering resulting from a decreased specific surface area of the carrier. This scattering leads to degrading the representation of a solid portion especially in full color printing with many solid portions.

### Resin Layer

The resin layer may contain resin and other optional other components. The resin used in the resin layer can be a material known in the art that can be adequately charged. It includes, but is not limited to, a silicone resin, acrylic resin, or a combination thereof. Preferably, the composition for forming a resin layer contains a silane coupling agent.

The resin layer preferably has an average thickness of 0.05 to 0.50 μm.

### Measuring Method

### Calculation Method and Analysis of PET as Toner Composition Component

The content of PET can be calculated by any method. One way of analyzing is to separate each component from a toner using a gel permeation chromatography (GPC) and analyze each separated component as follows to calculate the mass ratio of each component.

In addition, the main components can be deducible from soft decomposition in methylation of the ester linking part of a resin structure according to the gas chromatography mass analysis at 300 degrees Celsius using a reactive agent (10 percent solution of tetramethyl ammonium hydroxide (TMAH) and methanol). Then the calibration curve is created based on total ion current chromatograph (TICC) strength to conduct quantitative analysis.

One way of separating each component by GPC is as follows.

In GPC measurements using tetrahydrofuran (THF) as the mobile phase, the eluate obtained undergoes preparatory steps, such as fraction collection, followed by the aggregation of fractions corresponding to the desired molecular weight range from the entire elution curve area.

The resulting eluate is subsequently condensed and dried with equipment such as an evaporator. Next, the solid residue is dissolved in a deuterated solvent such as deuterated chloroform or deuterated THF followed by ¹H-NMR measuring. Finally, the ratios of compositional monomers of the resin in the eluted components are calculated based on the integration ratio of each element.

Alternatively, an eluate can be concentrated, followed by hydrolysis using such a substance as sodium hydroxide. The decomposition products obtained are qualitatively and quantitatively analyzed by, for example, high-performance liquid chromatography (HPLC), to calculate the ratio of each compositional monomers.

### Method of Separating Toner's Compositional Component

A method of separating each component for analyzing the toner mentioned above is detailed below.

To begin with, 1 g of toner is placed in 100 mL of THF followed by stirring for 30 minutes at 25 degrees Celsius to obtain a solution in which a soluble portion is dissolved.

This solution is filtered with a 0.2 μm membrane filter to obtain the THD soluble portion in the toner.

Then this soluble portion is dissolved in THF to make a sample for GPC measuring, which is infused into GPC for use in molecular weight measuring of each resin mentioned above.

Simultaneously, a fraction collector is disposed at the exit of the eluate of GPC to separate the eluate by preparatory work by a particular count. An eluate is obtained per 5 percent of the area ratio from the initiation of elution of the elution curve (initial rise of the curve).

Next, 30 mg of each elution is dissolved in 1 mL of deuterated chloroform followed by adding 0.05 percent by volume of tetra methyl silane (TMS) as a reference material. A 5 mm diameter NMR measuring glass tube is filled with this solution followed by 128 time integrations at temperatures of 23 to 25 degrees Celsius using a nuclear magnetic resonance device (JNM-AL400, available from JEOL Ltd.) to obtain spectra.

The monomer compositions such as the PET resin contained in the toner and the constitutional ratio can be obtained from the peak integrated ratio of the spectra obtained.

### Method of Measuring Carbon-14 Concentration

The carbon-14 concentration of the toner is measured by radiocarbon dating. The toner is burnt to reduce carbon dioxide (CO₂) in the particles, thereby obtaining graphite (C). Carbon-14 concentration of graphite is measured by an Accelerator Mass Spectroscopy (AMS), available from Beta Analytic.

### Confirmation of Core-Shell Structure

### Observation and Measurement by TEM

The toner manufactured is embedded and cured. An ultra thin piece with a thickness of about 100 nm of the toner is prepared with an ultramicrotome (ULTRACUT UCT, using a diamond knife, available from Leica Corporation).

The sample is exposed to gas of ruthenium tetroxide, osmium tetroxide, or another 5 dyeing agent to distinguish the crystalline polyester resin phase from the other portions. The time spent in the exposure is appropriately adjusted depending on the contrast during observation. The crystalline polyester resin phase is observed to have a lamella structure in many cases. Thereafter, the sample is observed with TEM, JEM-2100, available from JEOL Ltd. at an accelerating voltage of 100 kV. Depending on the compositions of the crystalline polyester resin and amorphous polyester resin, they can be distinguished without dyeing. In such a case, the structure is evaluated undyed. The composition can be contrasted by another method such as selective etching. Observing and evaluating the polyester resin portion using a TEM is also allowed after such a pre-treatment.

### Toner Accommodating Unit

The toner accommodating unit in the present disclosure contains toner in a unit capable of accommodating the toner. The toner accommodating unit includes a toner accommodating container, a developing device, and a process cartridge.

The toner accommodating container is a vessel containing a toner.

The developing unit refers to a device that accommodates toner and develops with the toner.

The process cartridge refers to an integrated unit that includes at least an image bearer and a developing device, accommodates toner, and is detachably attachable to an image forming apparatus. The process cartridge may furthermore include at least one member selected from the group consisting of a charging device, an irradiating device, and a cleaning device.

### Image Forming Apparatus

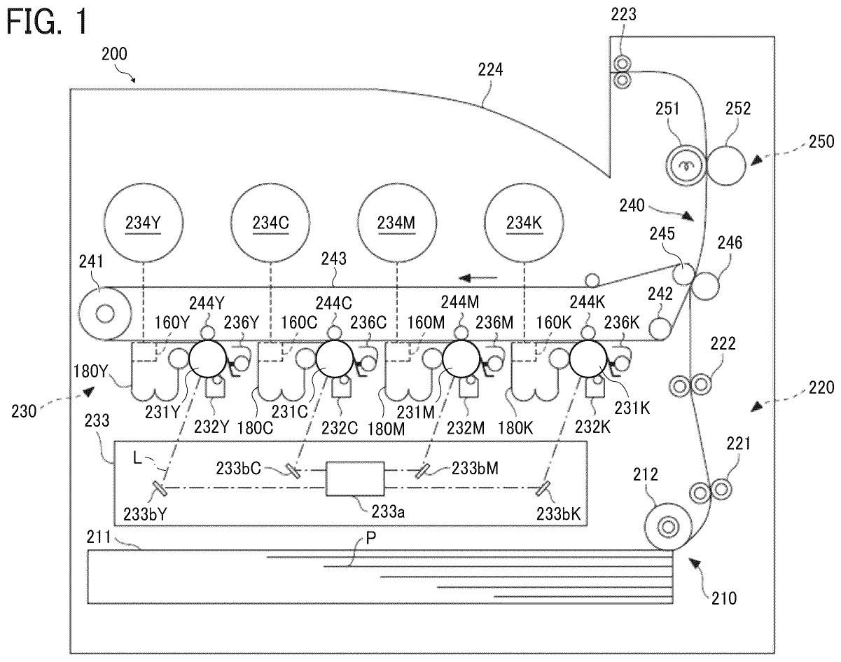

Next, an embodiment of image forming with the image forming apparatus of the present disclosure is described with reference to FIG. 1. One of the image forming apparatuses in the present embodiment is a printer. However, the image forming apparatus is not particularly limited to an apparatus such as a printer, a photocopier, a facsimile machine, or a multifunction peripheral as long as it can form images with toner.

An image forming apparatus 200 includes a sheet feeding unit 210, a conveyance unit 220, an image forming part (latent electrostatic image forming device) 230, a transfer unit (transfer device) 240, and a fixing unit (fixing device) 250.

The sheet feeding unit 210 includes a sheet feeding cassette 211 on which sheets to be fed are piled and a feeding roller 212 that feeds a sheet (recording medium) P piled on the sheet feeding cassette 211 one by one.

The conveyance unit 220 includes a roller 221 for conveying the sheet P fed by the feeding roller 212 toward the transfer unit 240, a pair of timing rollers 222 for pinching the front end of the sheet P conveyed by the roller 221 on standby and sending out the sheet P to the transfer unit 240 at a particular timing, and ejection rollers 223 for ejecting the sheet P on which a color toner image is fixed by the fixing unit 250 to an ejection tray 224.

The image forming part 230 includes an image forming unit (latent electrostatic image bearer) 234Y that forms an image using a developing agent containing yellow toner, an image forming unit 234C that forms an image using a developing agent containing cyan toner, an image forming unit 234M that forms an image using a developing agent containing magenta toner, and an image forming unit 234K that forms an image using a developing agent containing black toner, sequentially standing from left to right in the drawing with a particular interval. The image forming part 230 also includes a charger 232 (232Y, 232M. 232C. 232K) and an irradiator 233 (233Y, 233C, 233M. 233K) that emits beams of light L. The irradiator 233 includes a light source 233a and a polygon mirror 233b (233bY, 233bM, 233bC, 233bK) that redirects the beams of light L to the charger 232.

An arbitrary image forming unit of the image forming units 234Y, 234C, 234M, and 234K is called an image forming unit.

In addition, the developing agent contains toner and carrier. The four image forming units have substantially the same structure except for the individual developing agents used for respective image forming units.

The transfer unit 240 includes a driving roller 241, a driven roller 242, an intermediate transfer belt 243 disposed rotatable counterclockwise in the drawing in accordance with the drive of the driving roller 241, a primary transfer roller 244 (244Y, 244C, 244M, and 244K) disposed facing the drum photoconductor 231 (231Y, 231C, 231M, and 231K) with the intermediate transfer belt 243 therebetween, and a secondary facing roller 245 and a secondary transfer roller 246 disposed facing each other at the point of the toner image transferred to the surface of the sheet P with the intermediate transfer belt 243 therebetween.

A fixing device 250 with a heater inside includes a fixing belt 251 for heating the sheet P and a pressing roller 252 for forming a nip with the fixing belt 251 by rotatably pressing it. Heat is applied with pressure to the color toner image on the sheet P at the nipping portion, thereby fixing the color toner image. The sheet P on which the color toner image is fixed is ejected to the ejection tray 224 by the ejection rollers 223, which completes a series of image forming process.

### Process Cartridge

The process cartridge relating to the present disclosure is made to be detachably attachable to an image forming apparatus. It includes at least a latent electrostatic image bearer and a developing device that renders the latent electrostatic image visible with a developing agent containing the toner of the present disclosure to form a toner image. The process cartridge of the present disclosure may furthermore include other optional devices.

The developing device includes at least a developing agent container that contains a developing agent and a developing agent bearer that bears and conveys the developing agent in the developing agent container. The developing device may furthermore optionally include a regulating member for regulating the thickness of the developing agent borne on the bearer.

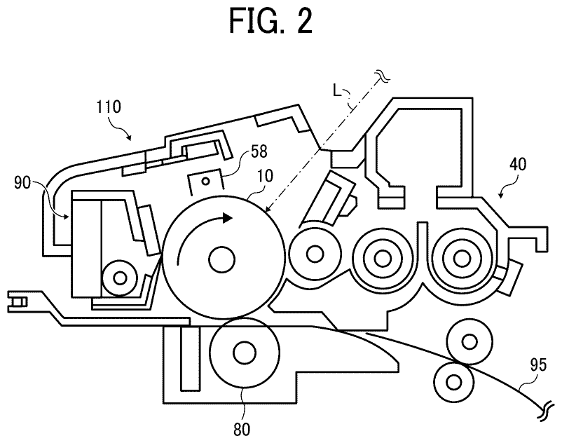

FIG. 2 is a diagram illustrating an example of the process cartridge relating to the present disclosure. The process cartridge 110 includes a drum photoconductor (latent electrostatic image bearer) 10, a corona charger 58, a developing device 40, a transfer roller 80, and a cleaner 90.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Hereinafter, the present disclosure is described in more detail based on Examples, but the technical scope of the present disclosure is not limited to thereto.

“Parts” represents parts by mass and “percent” represents percent by mass unless otherwise specified in the following description.

### Synthesis of Amorphous Polyester Resin A-1

Plant-derived propylene glycol, recycled resin-derived terephthalic acid, and plant-derived succinic acid were placed in a four-necked flask equipped with a nitrogen introducing tube, a dehydration tube, a stirrer, and a thermocouple. They were mixed at a molar ratio of terephthalic acid to succinic acid at 86:14 and a molar ratio of hydroxyl group to carboxyl group (OH to COOH) at 1.1:1. Titanium tetraisopropoxide (500 ppm relative to the resin portion) was added, and the mixture was heated to 230 degrees Celsius under atmospheric pressure for eight hours, followed by an additional four hours under reduced pressure ranging from 10 to 15 mmHg. Trimellitic anhydride was then added to the reaction vessel to achieve a concentration of 1 mol percent relative to the total resin components. The reaction was continued at 180 degrees Celsius under atmospheric pressure for three hours, resulting in the formation of Amorphous Polyester Resin A-1.

### Synthesis of Amorphous Polyester Resin B-1

Plant-derived propylene glycol, an adduct of bisphenol A with 2 mols of propylene oxide, recycled resin-based terephthalic acid, plant-derived succinic acid, and adipic acid were placed in a four-necked flask equipped with a nitrogen inlet tube, a dehydration tube, a stirrer, and a thermocouple. They were mixed at a molar ratio of propylene glycol to the adduct of bisphenol A with 2 moles of propylene oxide at 20:80, a molar ratio of terephthalic acid to succinic acid at 70:30, and a molar ratio of hydroxyl group to carboxyl group (OH to COOH) at 1.1:1. Titanium tetraisopropoxide (500 ppm relative to the resin portion) was added, and the mixture was heated to 230 degrees Celsius under normal pressure for eight hours, followed by an additional four hours under reduced pressure ranging from 10 to 15 mmHg. Trimellitic anhydride was then added to the reaction vessel to achieve a concentration of 1 mol percent relative to the total resin components. The reaction was continued at 180 degrees Celsius under normal pressure for four hours, resulting in the formation of Amorphous Polyester Resin B-1.

### Synthesis of Amorphous Polyester Resin B-2

Plant-derived propylene glycol, an adduct of bisphenol A with 2 mols of propylene oxide, recycled resin-based terephthalic acid and isophthalic acid, plant-derived succinic acid, and adipic acid were placed in a four-necked flask equipped with a nitrogen inlet tube, a dehydration tube, a stirrer, and a thermocouple. They were mixed at a molar ratio of propylene glycol to the adduct of bisphenol A with 2 moles of propylene oxide of 20:80, a molar ratio of terephthalic acid/isophthalic acid/succinic acid/adipic acid at 60:6:14:20, and a molar ratio of hydroxyl group to carboxyl group (OH to COOH) at 1.1:1. Titanium tetraisopropoxide (500 ppm relative to the resin portion) was added, and the mixture was heated to 230 degrees Celsius under normal pressure for eight hours, followed by an additional four hours under reduced pressure ranging from 10 to 15 mmHg. Trimellitic anhydride was then added to the reaction vessel to achieve a concentration of 1 mol percent relative to the total resin components. The reaction was continued at 180 degrees Celsius under normal pressure for four hours, resulting in the formation of Amorphous Polyester Resin B-2.

Synthesis of Amorphous Polyester Resin B-3 Plant-derived propylene glycol, an adduct of bisphenol A with 2 mols of propylene oxide, recycled resin-based terephthalic acid, and plant-derived succinic acid were placed in a four-necked flask equipped with a nitrogen inlet tube, a dehydration tube, a stirrer, and a thermocouple. They were mixed at a molar ratio of propylene glycol to the adduct of bisphenol A with 2 moles of propylene oxide at 30:70, a molar ratio of terephthalic acid to succinic acid at 86:14, and a molar ratio of hydroxyl group to carboxyl group (OH to COOH) at 1.1:1. Titanium tetraisopropoxide (500 ppm relative to the resin portion) was added, and the mixture was heated to 230 degrees Celsius under normal pressure for eight hours, followed by an additional four hours under reduced pressure ranging from 10 to 15 mmHg. Trimellitic anhydride was then added to the reaction vessel to achieve a concentration of 1 mol percent relative to the total resin components. The reaction was continued at 180 degrees Celsius under normal pressure for four hours, resulting in the formation of Amorphous Polyester Resin B-3

### Synthesis of Amorphous Polyester Resin B-4

Plant-derived propylene glycol, an adduct of bisphenol A with 2 moles of propylene oxide, recycled resin-based ethylene glycol, recycled resin-based terephthalic acid, recycled resin-based isophthalic acid, and plant-derived succinic acid were placed in a four-necked flask equipped with a nitrogen inlet tube, a dehydration tube, a stirrer, and a thermocouple. They were mixed at a molar ratio of propylene glycol, the adduct of bisphenol A with 2 moles of propylene oxide, and ethylene glycol at 30:60:10, a molar ratio of terephthalic acid/isophthalic acid/succinic acid/adipic acid at 80:14:6, and a molar ratio of hydroxyl group to carboxyl group (OH to COOH) at 1.1:1. Titanium tetraisopropoxide (500 ppm relative to the resin portion) was added, and the mixture was heated to 230 degrees Celsius under normal pressure for eight hours, followed by an additional four hours under reduced pressure ranging from 10 to 15 mmHg. Trimellitic anhydride was then added to the reaction vessel to achieve a concentration of 1 mol percent relative to the total resin components. The reaction was continued at 180 degrees Celsius under normal pressure for four hours, resulting in the formation of Amorphous Polyester Resin B-4.

### Synthesis of Amorphous Polyester Resin B-5

Propylene glycol, an adduct of bisphenol A with 2 mols of propylene oxide, terephthalic acid, and succinic acid were placed in a four-necked flask equipped with a nitrogen introducing tube, a dehydration tube, a stirrer, and a thermocouple at a molar ratio of propylene glycol to the adduct of bisphenol A with 2 moles of propylene oxide of 60:40, a molar ratio of terephthalic acid to succinic acid of 86:14, and a molar ratio of hydroxyl group to carboxyl group, OH to COOH, of 1.1:1 followed by allowing to react together with titanium tetraisopropoxide (500 ppm to the resin portion) at 230 degrees Celsius under normal pressure for eight hours and further react under a reduced pressure of from 10 to 15 mmHg for four hours. Then trimellitic anhydride was placed in the reaction container to achieve a proportion of 1 mol percent to the entire resin component followed by allowing to react at 180 degrees Celsius under normal pressure for four hours, thereby obtaining Amorphous Polyester Resin B-5.

### Synthesis of Amorphous Polyester Resin MB for Master Batch

Plant-derived propylene glycol, terephthalic acid, and plant-derived succinic acid were placed in a four-necked flask equipped with a nitrogen introducing tube, a dehydration tube, a stirrer, and a thermocouple at a molar ratio of terephthalic acid to succinic acid of 86:14 and a molar ratio of hydroxyl group to carboxyl group, OH to COOH, at 1.1:1 followed by allowing to react together with titanium tetraisopropoxide (500 ppm to the resin portion) at 230 degrees Celsius under normal pressure for eight hours and further react under a reduced pressure of from 10 to 15 mmHg for four hours. Then trimellitic anhydride was placed in the reaction container to achieve a proportion of 1 mol percent to the entire resin component followed by allowing to react at 180 degrees Celsius under normal pressure for four hours, thereby obtaining Amorphous Polyester Resin MB for Master Batch.

### Synthesis of Crystalline Polyester Resin C-1

Plant-derived 1,8-octane dicarboxylic acid and plant-derived ethylene glycol were placed in a 5 L four-necked flask equipped with a nitrogen introducing tube, a dehydration tube, a stirrer, and a thermocouple at a molar ratio of hydroxyl group to carboxyl group, OH/COOH, at 1.1:1. Moreover, trimellitic anhydride was added to achieve 0.047 molar ratio, followed by allowing to react together with titanium tetraisopropoxide (500 ppm to the resin portion) at 180 degrees Celsius for ten hours. The system was then heated to 200 degrees Celsius and allowed to react for three hours followed by allowing to react under a pressure of 8.3 kPa for two hours to obtain Crystalline Polyester Resin C-1.

### Synthesis of Crystalline Polyester Resin C-2

Crystalline Polyester Resin C-2 was obtained in the same manner as in Synthesis of Crystalline Polyester Resin C-1 except for changing to plant-derived 1,4-butanediol.

### Synthesis of Crystalline Polyester Resin C-3

Crystalline Polyester Resin C-3 was obtained in the same manner as in Synthesis of Crystalline Polyester Resin C-1 except for changing to plant-derived 1,10-decane dicarboxylic acid and plant-derived 1,4-butanediol.

### Synthesis of Crystalline Polyester Resin C-4

Crystalline Polyester Resin C-4 was obtained in the same manner as in Synthesis of Crystalline Polyester Resin C-1 except for changing to plant-derived succinic acid and plant-derived 1,4-butanediol.

### Synthesis of Crystalline Polyester Resin C-5

Crystalline Polyester Resin C-5 was obtained in the same manner as in Synthesis of Crystalline Polyester Resin C-1 except for changing to plant-derived decanediol.

### Preparation of Liquid Dispersion 1 of Crystalline Polyester Resin

A total of 350 parts of Crystalline Polyester Resin C-1, 210 parts of methylethyl ketone, and 61.8 parts of isopropyl alcohol were charged in a separable flask. The mixture was mixed and dissolved sufficiently at 50 degrees Celsius, followed by adding 16.24 parts of 10 percent ammonium aqueous solution dropwise. The heating temperature was lowered to 65 degrees Celsius and deionized water was added dropwise to the resulting solution at a liquid feeding speed of 8 g/min using a liquid feeding pump during stirring to obtain a uniformly clouded liquid. Then the liquid feeding speed was increased to 12 g/min to add deionized water until the total amount of the liquid reached 1,400 parts. Thereafter, the solvent was removed under a reduced pressure to obtain Liquid Dispersion 1 of Crystalline Polyester Resin.

### Preparation of Liquid Dispersions 2 to 5 of Crystalline Polyester Resin

Liquid Dispersions 2 to 5 of Crystalline Polyester Resin were obtained in the same manner as in Preparation of Liquid Dispersion 1 of Crystalline Polyester Resin except that Crystalline Polyester Resin C-1 was changed to Crystalline Polyester Resins C-2 to C-5, respectively.

### Preparation of Liquid Dispersion of Wax

A total of 180 parts of ester wax (WE-11, synthetic wax of plant-derived monomer, melting point of 67 degrees Celsius, available from NOF CORPORATION) and 17 parts of anionic surfactant (NEOGEN SC, sodium dodecylbenzenesulfonate, available from DKS Co., Ltd.) were added to 720 parts of deionized water.

The resulting mixture was subjected to dispersion with a homogenizer to obtain Liquid Dispersion W-1 of Wax while being heated to 90 degrees Celsius. The concentration of the solid portion of the liquid dispersion of Wax was 25 percent.

### Preparation of Master Batch MB-1

A total of 1,200 parts of water, 500 parts of carbon black (Printex 35, available from Degussa AG, DBP oil absorption amount of 42 ml/100 mg, PH of 9.5), and 500 parts of Amorphous Polyester Resin MB for Master Batch were admixed with a Henschel Mixer (available from NIPPON COKE & ENGINEERING. CO., LTD.). The mixture was kneaded at 150 degrees Celsius for 30 minutes using two rolls and rolled and cooled down followed by pulverization with a pulverizer to obtain Master Batch MB-1.

### Example 1

### Preparation of Oil Phase

A total of 100 parts of Liquid Dispersion 1 of Crystalline Polyester Resin, 50 parts of Liquid Dispersion W-1 of Wax, 650 parts of Amorphous Polyester Resin B-1, and 100 parts of Master Batch MB-1 were placed in a container and mixed with a TK homomixer (available from PRIMIX Corporation) at 5,000 rpm for 60 minutes to obtain Oil Phase 1.

The number of parts by mass mentioned above represents the solid portion in each raw material.

### Preparation of Aqueous Phase

A total of 990 parts of water, 20 parts of sodium dodecyl sulfate, and 90 parts of ethyl acetate were mixed and stirred to obtain a milky white liquid. This liquid was determined as aqueous phase 1.

### Emulsification

A total of 20 parts of 28 percent ammonium water was added to 900 parts of Oil Phase 1 while being stirred with a TK homomixer at a rate of rotation of 8,000 rpm. After ten minutes mixing, 1,200 parts of Aqueous Phase 1 was slowly added dropwise to the liquid mixture to obtain Emulsified Slurry 1.

### Removal of Solvent

Emulsified Slurry 1 was placed in a container equipped with a stirrer and a thermometer followed by purging Emulsified Slurry 1 of the solvent at 30 degrees Celsius for 180 minutes to obtain Solvent-purged Slurry 1.

### Preparation of Shell

Shell Solvent-purged Slurry 1 was obtained in the same manner as in Example 1 except that, in the preparation of the oil phase, 100 parts of Liquid Dispersion 1 of Crystalline Polyester Resin, 50 parts of Liquid Dispersion W-1 of Wax, 650 parts of Amorphous Polyester Resin B-1, and 100 parts of Master Batch MB-1 were changed to Amorphous Polyester Resin A-1, and, in the preparation of the aqueous phase, 20 parts of sodium dodecyl sulfate were reduced to 0 parts, and ethyl acetate was replaced with MEK.

### Aggregation

A total of 100 parts of 3 percent solution of magnesium chloride was added dropwise to 900 parts of Solvent-purged Slurry 1, followed by stirring for five minutes. The mixture was then heated to 60 degrees Celsius. A total of 200 parts of Solvent-purged Slurry 1 was added when the particle diameter grew to 5.0 m, followed by adding dropwise 100 parts of 3 percent solution of magnesium chloride. After five minutes stirring, 50 parts of an aqueous solution of sodium sulfate was added to complete the aggregation to obtain Aggregated Slurry 1.

### Fusion

Aggregated Slurry 1 was stirred and heated to 70 degrees Celsius. Aggregated Slurry 1 heated was cooled down when the average circularity reached a target of 0.957. Slurry Dispersion 1 was thus obtained.

### Rinsing and Drying

After reduced pressure filtration of 100 parts of Slurry Dispersion 1,

(1): A total of 100 parts of deionized water was added to the filtered cake, mixed using a TK Homomixer at 12,000 rpm for 10 minutes, and subsequently filtered.
(2): A total of 100 parts of sodium hydroxide at 10 percent was admixed with the filtered cake obtained in the (1), using a TK Homomixer at 12,000 rpm for 30 minutes, and then filtered under reduced pressure.
(3): A total of 100 parts of hydrochloric acid at 10 percent was admixed with the filtered cake obtained in the (2), using a TK Homomixer at 12,000 rpm for 10 minutes, and subsequently filtered.
(4): A total of 300 parts of deionized water was added to the filtered cake obtained in (3) and the resulting mixture was mixed by a TK HOMOMIXER at a rate of rotation of 12,000 rpm for 10 minutes followed by filtering. The processes of (1) to (4) were carried out twice to obtain Filtered Cake 1.

The obtained filtered cake 1 was dried with a circulation dryer at 45 degrees Celsius for 48 hours. The dried cake obtained was sieved with a screen with an opening of 75 μm to obtain Mother Resin Particle 1.

Treatment with External Additive

A total of 2.0 parts of an external additive, hydrophobic silica (HDK-2000, available from Clamant AG), was admixed with 100 parts of Mother Resin Particle 1 using a Henschel Mixer, followed by filtering with a screen having an opening of 500 meshes to obtain Resin Particle 1.

### Examples 2 to 7 and Comparative Examples 1 to 3

Resin Particles 2 to 10 were prepared in the same manner as Resin Particle 1 except that the types of Crystalline Resin C and Amorphous Resin B added in each process were changed as shown in Table 1.

TABLE 1

| Example/ | | Core resin | | | Shell resin |
|---|---|---|---|---|---|
| Comparative | Resin | Amorphous | Crystalline | Master | Amorphous |
| Example | particle | polyester | polyester | batch | polyester |
| No. | No. | resin B | resin C | MB | resin A |
| Example 1 | Resin | B-1 | C-1 | MB-1 | A-1 |
| | particle | | | | |
| | 1 | | | | |
| Example 2 | Resin | B-1 | C-2 | MB-1 | A-1 |
| | particle | | | | |
| | 2 | | | | |
| Example 3 | Resin | 8-1 | C-3 | MB-1 | A-1 |
| | particle | | | | |
| | 3 | | | | |
| Example 4 | Resin | B-1 | C-4 | MB-1 | A-1 |
| | particle | | | | |
| | 4 | | | | |
| Example 5 | Resin | B-2 | C-3 | MB-1 | A-1 |
| | particle | | | | |
| | 5 | | | | |
| Example 6 | Resin | B-3 | C-3 | MB-1 | A-1 |
| | particle | | | | |
| | 6 | | | | |
| Example 7 | Resin | B-4 | C-1 | MB-1 | A-1 |
| | particle | | | | |
| | 7 | | | | |
| Comparative | Resin | B-1 | C-4 | MB-1 | A-1 |
| Example 1 | particle | | | | |
| | 8 | | | | |
| Comparative | Resin | B-1 | C-5 | MB-1 | A-1 |
| Example 2 | particle | | | | |
| | 9 | | | | |
| Comparative | Resin | B-5 | C-1 | MB-1 | A-1 |
| Example 3 | particle | | | | |
| | 10 | | | | |

These resin particles were evaluated regarding environment ratio, low temperature fixability, high temperature storage stability, and compatibility to environment.

The evaluation methods are described below and the evaluation results are shown in Table 2.

### Evaluation Method

### Low Temperature Fixability

A developing agent was obtained by mixing the carrier for use in imagio MP C5503, available from Ricoh Co., Ltd., with the resin particle obtained as described above to achieve a concentration of the resin particle of 5 percent by mass.

This developing agent was placed in the unit of imagio MP C5503, manufactured by Ricoh Co., Ltd. Then an oblong solid image of 2 cm×15 cm was printed on PPC paper type 6000<70 W>, A4 grain long (GL), available from Ricoh Co., Ltd., with an amount of toner attached of 0.40 mg/cm². The image was printed using the fixing roller at different surface temperatures to check whether the remaining developed image of the solid image was fixed at a position other than the target portion, which is a phenomenon called cold offset, to evaluate low temperature fixability.

### Evaluation Criteria

A: lower than 110 degrees Celsius
B: 110 to lower than 120 degrees Celsius
C: 120 to lower than 130 degrees Celsius
D: not lower than 130 degrees Celsius

### High Temperature Storage Stability (Thermal Storage Stability)

A glass container for evaluating the high temperature storage stability was filled with the toner obtained and was allowed to rest in a thermostatic chamber at 50 degrees Celsius for 24 hours.

This toner was then cooled down to 24 degrees Celsius and subjected to the penetration test according to JIS K2235-1991 (Petroleum Waxes) format.

The evaluation criteria of the high temperature storage stability based on penetration is as follows.

### Evaluation Criteria

A: not less than 25 mm
B: 10 to less than 25 mm
C: Less than 10 mm

### Compatibility to Environment

The ratio of the sum of the biomass-derived resin and recycled-derived resin to the mass of the resin particle is defined as the resin ratio as shown in the following calculation formula. This resin ratio was analyzed to evaluate compatibility to environment according to the following evaluation criteria.

Resin ratio=[(biomass-derived resin+recycled-derived resin)/resin particle]×100

### Evaluation Criteria

A: Resin ratio of 50 or more percent
B: Resin ratio of 40 to less than 50 percent
C: Resin ratio of 30 to less than 40 percent
D: Resin ratio of less than 30 percent

The results are shown in Table 2.

TABLE 2

| | | | Evaluation | | |
|---|---|---|---|---|---|
| | | Compatibility | | High | |
| Example/ | Resin | to | Low | temperature | Compatibility |
| Comparative | particle | environment | temperature | storage | to |
| Example No. | No. | (percent) | fixability | stability | environment |
| Example 1 | Resin | 33 | C | B | C |
| | particle | | | | |
| | 1 | | | | |
| Example 2 | Resin | 33 | C | B | C |
| | particle | | | | |
| | 2 | | | | |
| Example 3 | Resin | 33 | C | B | C |
| | particle | | | | |
| | 3 | | | | |
| Example 4 | Resin | 33 | C | B | C |
| | particle | | | | |
| | 4 | | | | |
| Example 5 | Resin | 45 | B | B | B |
| | particle | | | | |
| | 5 | | | | |
| Example 6 | Resin | 52 | A | A | A |
| | particle | | | | |
| | 6 | | | | |
| Example 7 | Resin | 60 | B | A | A |
| | particle | | | | |
| | 7 | | | | |
| Comparative | Resin | 33 | D | B | C |
| Example 1 | particle | | | | |
| | 8 | | | | |
| Comparative | Resin | 33 | D | A | C |
| Example 2 | particle | | | | |
| | 9 | | | | |
| Comparative | Resin | 26 | D | A | D |
| Example 3 | particle | | | | |
| | 10 | | | | |

Aspects of the present disclosure are, for example, as follows:

Aspects of the present disclosure are, for example, as follows:

### Aspect 1

A resin particle contains a resin B containing a component derived from at least one of polyethylene terephthalate or polybutylene terephthalate and a biomass-derived resin C containing a linear aliphatic alcohol with 2 to 4 carbon atoms and a linear aliphatic acid with 10 to 12 carbon atoms, wherein the resin particle has a core shell structure of a core resin and a shell resin, the core resin contains a crystalline resin, and the proportion of the sum of the resin B and the resin C to 100 percent by mass of the resin particle is 30 or greater percent by mass.

### Aspect 2

The resin particle according to Aspect 1 mentioned above, wherein the resin B contains a structural unit derived from terephthalic acid and a structural unit derived from isophthalic acid having a proportion to the structural unit derived from terephthalic acid of 1 or greater percent.

### Aspect 3

The resin particle according to Aspect 1 or 2 mentioned above, wherein the proportion of the sum of the resin B and the resin C to 100 percent by mass of the resin particle is 50 or greater percent by mass.

### Aspect 4

A toner contains the resin particle of any one of Aspects 1 to 3 mentioned above.

### Aspect 5

A toner accommodating unit accommodating the toner of Aspect 4 mentioned above.

### Aspect 6

An image forming apparatus includes a latent electrostatic image bearer, a latent electrostatic image forming device to form a latent electrostatic image on the latent electrostatic image bearer, a developing device to develop the latent electrostatic image on the latent electrostatic image bearer with the toner of Aspect 4 mentioned above to form a toner image, a transfer device to transfer the toner image on the latent electrostatic image bearer onto a surface of a recording medium, and a fixing device to fix the toner image on the surface of the recording medium.

### Aspect 7

An image forming method includes forming a latent electrostatic image on a latent electrostatic image bearer, developing the latent electrostatic image formed on the latent electrostatic image bearer with the toner of Aspect4 mentioned above to form a toner image, transferring the toner image formed on the latent electrostatic image bearer to the surface of a recording medium, and fixing the toner image on the surface of the recording medium.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A resin particle comprising:
a resin B comprising:
a component derived from at least one of polyethylene terephthalate or polybutylene terephthalate; and
a biomass-derived resin C comprising:
a linear aliphatic alcohol with 2 to 4 carbon atoms; and
a linear aliphatic acid with 10 to 12 carbon atoms,
wherein the resin particle has a core shell structure of a core resin and a shell resin,
the core resin comprises a crystalline resin, and
a proportion of a sum of the resin B and the biomass-derived resin C to 100 percent by mass of the resin particle is 30 or greater percent by mass.

2. The resin particle according to claim 1,
wherein the resin B comprises a structural unit derived from terephthalic acid and a structural unit derived from isophthalic acid with a proportion to the structural unit derived from terephthalic acid of 1 or greater percent.

3. The resin particle according to claim 1,
wherein the proportion of the sum of the resin B and the biomass-derived resin C to 100 percent by mass of the resin particle is 50 or greater percent by mass.

4. A toner comprising the resin particle of claim 1.

5. A toner accommodating unit accommodating the toner of claim 4.

6. An image forming apparatus comprising:
a latent electrostatic image bearer;
a latent electrostatic image forming device to form a latent electrostatic image on the latent electrostatic image bearer;
a developing device to develop the latent electrostatic image on the latent electrostatic image bearer with the toner of claim 4 to form a toner image;
a transfer device to transfer the toner image on the latent electrostatic image bearer onto a surface of a recording medium; and
a fixing device to fix the toner image on the surface of the recording medium.

7. An image forming method comprising:
forming a latent electrostatic image on a latent electrostatic image bearer;
developing the latent electrostatic image formed on the latent electrostatic image bearer with the toner of claim 4 to form a toner image;
transferring the toner image formed on the latent electrostatic image bearer to a surface of a recording medium; and
fixing the toner image on the surface of the recording medium.
